(19) United States
(12) Patent Application Publication
(10) Pub. No.: US 2014/0160019 A1
(43) Pub. Date: Jun. 12, 2014

(54) METHODS FOR ENHANCING USER INTERACTION WITH MOBILE DEVICES

(71) Applicant: NVIDIA CORPORATION, Santa Clara, CA (US)

(72) Inventors: Venkata R. Anda, San Jose, CA (US); Guanghua Zhang, Sunnyvale, CA (US); Michael Lin, Fremont, CA (US)

(73) Assignee: NVIDIA CORPORATION, Santa Clara, CA (US)

(21) Appl. No.: 13/708,852

(22) Filed: Dec. 7, 2012

(51) Int. Cl. G09G 5/34

(52) U.S. Cl. CPC G09G 5/34
USPC 345/158

(57) ABSTRACT

A method for enhancing user interaction with mobile electronic devices is presented. The method includes determining screen orientation on the device by first detecting the presence of a user using data captured by a camera of the portable electronic device. The method further includes searching the data from the camera for a plurality of physical characteristics of the user if a user is detected. The method also includes determining a facial orientation of the user based on information regarding at least one physical characteristic of the user determined from the data. Finally, the method includes setting a screen orientation of a display device of the portable electronic device based on the determined facial orientation of the user.

### FIELD OF THE INVENTION

Embodiments according to the present invention generally relate to portable electronic devices and more specifically to methods for enhancing user interaction with portable electronic devices.

### BACKGROUND OF THE INVENTION

As portable electronic devices, such as cell phones, have become more compact and the number of functions performed by a given device increases, it has become increasingly problematic to design a user interface that allows users to easily interact with a multifunctional device. The challenge is particularly significant for handheld portable devices, which due to their smaller screens and form factors are incapable of dedicating much space, either on-screen for touch-screen devices or on the device itself, for buttons to access the various features. Some portable communication devices have attempted to address this problem by increasing the density of pushbuttons or overloading the functions of the existing pushbuttons. Other devices have designed complex menu systems to allow a user to access the various device features. These conventional user interfaces often result in complicated key sequences and menu hierarchies that the user needs to navigate to access even the simplest features.

Many such conventional user interfaces are also inflexible. They may prevent a user interface from being configured and/or adapted in accordance with a user's frequent actions or behaviors. When coupled with the time consuming requirement to memorize multiple key sequences and menu hierarchies, and the difficulty in activating a desired pushbutton, such inflexibility is frustrating to most users. This presents a significant problem because the user interface is the gateway through which many of the device's features are activated and through which the user receives responses to user actions or behaviors, including user attempts to access a device's features, tools and functions. As such, the user interface needs to be configured for maximum efficiency and ease of use.

### BRIEF SUMMARY OF THE INVENTION

Accordingly, a need exists for systems and methods for enhancing users' interactions with a mobile device. In one embodiment, the user's interactions with a mobile device are enhanced by sensing the presence of a user and detecting the location and orientation of the head, face, or the eyes of the user in order to automatically and adaptively configure certain settings on the device, including the screen power saving timer, the screen orientation and auto-focusing for the device. By sensing the presence of the user, one embodiment of the present invention avoids the inconvenience to the user of manually interacting with the device in order to keep the display on while, at the same time, retaining the benefits of power consumption. Also by detecting the orientation of the user's head, face or eyes, another embodiment of the present invention allows the screen orientation to be automatically configured accurately even when or if the orientation (through gyro or accelerometer) sensor fails to provide an accurate measurement because the device is oriented in the horizontal plane. Finally, automatic detection of the location of the user's head, face or eyes can help facilitate auto-focusing on the image captured by the user-facing camera on the device.

In one embodiment, a method for enhancing user interaction with mobile electronic devices is presented. The method includes determining screen orientation on the device by first detecting the presence of a user using data from a camera of the portable electronic device. The method further includes searching the data from the camera for a plurality of physical characteristics of the user if a user image is detected. The method also includes determining a facial orientation of the user based on information regarding at least one physical characteristic of the user image determined from the data. Finally, the method includes setting a screen orientation of a display device of the portable electronic device based on the determined facial orientation of the user.

In one embodiment, a computer-readable storage medium having stored thereon, computer executable instructions that, if executed by a computer system cause the computer system to perform a method for determining screen orientation of a display panel on a portable electronic device is disclosed. The method includes determining screen orientation of a display panel on the device by first detecting the presence of a user using data from a camera of the portable electronic device. The method further includes searching the data from the camera for a plurality of physical characteristics of the user if a user image is detected. The method also includes determining a facial orientation of the user based on information regarding at least one physical characteristic of the user image determined from the data. Finally, the method includes setting a screen orientation of a display device of the portable electronic device based on the determined facial orientation of the user.

In one embodiment, a system for determining screen orientation on a portable electronic device is presented. The system comprises a display screen configured to display an image in a plurality of orientations, a memory, a camera and a processor. The processor is configured to detect the presence of a user using data from a camera of the portable electronic device, search the data from the camera for a plurality of physical characteristics of the user if a user image is detected, determine a facial orientation of the user based on information regarding at least one physical characteristic of the user determined from the data and set a screen orientation on the display screen of the portable electronic device based on the determined facial orientation of the user.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a perspective view showing the screen display of a cell phone change in accordance with accelerometer and/or gyroscope methods of adjusting screen orientation.

FIG. 2 is a perspective view showing a cell phone positioned in a horizontal plane.

FIG. 3 shows an exemplary operating environment in accordance with one embodiment of the present invention.

FIG. 4 is a high level block diagram representation showing the interconnections between the internal hardware or software components within a portable mobile device in accordance with one embodiment of the present invention.

FIG. 5 depicts a flowchart of an exemplary process of setting the screen power saving feature of a portable mobile device in accordance with on embodiment of the present invention.

FIG. 6 depicts a flowchart of an exemplary process setting the screen orientation of a portable mobile device in accordance with on embodiment of the present invention.

FIG. 7 depicts a flowchart of an exemplary process setting the auto-focus of a portable mobile device in accordance with on embodiment of the present invention.

FIG. 8 depicts a flowchart of an exemplary process setting the screen power saving feature, the screen orientation and auto-focus of a portable mobile device in accordance with on embodiment of the present invention.

FIGS. 9A-9D illustrates how the on screen orientation of an image on the display of a portable mobile device changes in relation to the facial orientation of the user in accordance with one embodiment of the present invention.

FIG. 10 is a more detailed block diagram of an exemplary computer system and illustrates the various hardware and software components with the orientation sensing module, auto-focusing module and screen power saving module for a portable mobile device, in accordance with one embodiment of the present invention.

In the figures, elements having the same designation have the same or similar function.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Notation and Nomenclature

Some portions of the detailed descriptions that follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

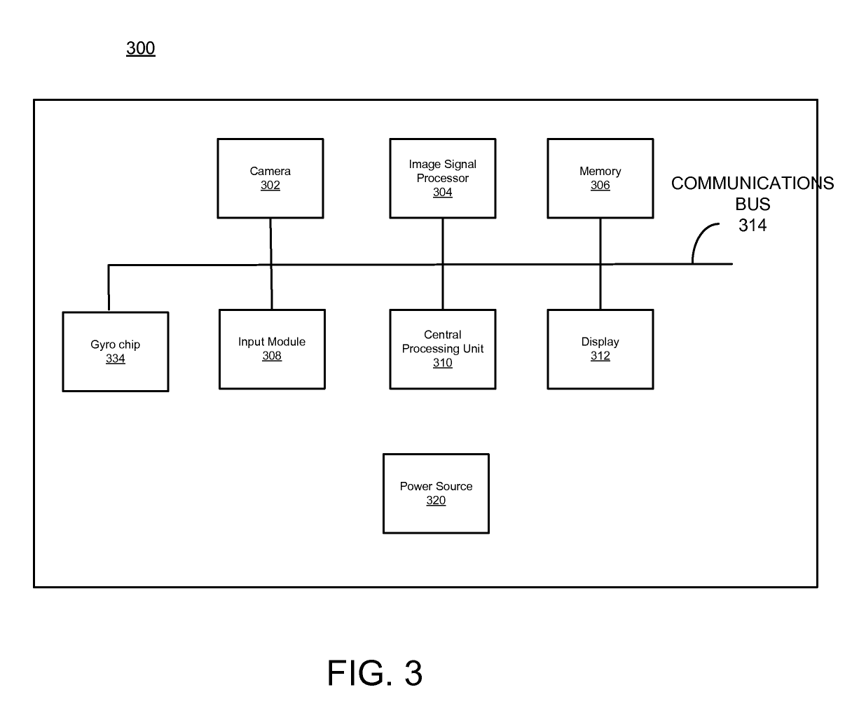

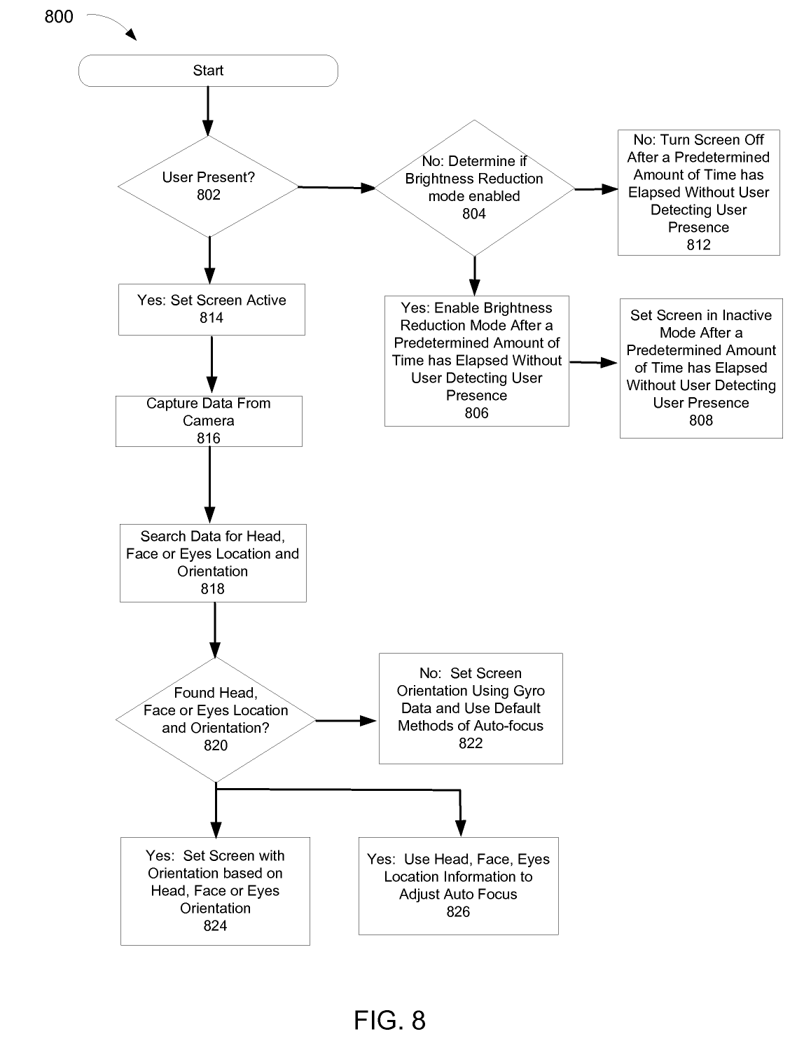

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “sensing,” “setting,” “configuring,” “detecting,” “capturing,” “allocating,” “associating,” “moving,” “orienting,” “controlling,” “processing,” “accessing,” “determining,” “identifying,” “caching,” “maintaining,” “comparing,” “detecting,” or the like, refer to actions and processes (e.g., flowchart 800 of FIG. 8) of a computer system or similar electronic computing device or processor (e.g., system 300 of FIG. 3). The computer system or similar electronic computing device manipulates and transforms data represented as physical (electronic) quantities within the computer system memories, registers or other such information storage, transmission or display devices.

For expository purposes, the term “horizontal” as used herein refers to a plane parallel to the plane or surface of an object, regardless of its orientation. The term “vertical” refers to a direction perpendicular to the horizontal as just defined. Terms such as “above,” “below,” “bottom,” “top,” “side,” “higher,” “lower,” “upper,” “over,” and “under” are referred to with respect to the horizontal plane.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

Methods for Enhancing User Interaction with Mobile Devices

Certain contemporary portable electronic devices have introduced ways of facilitating user experience by automating functions that formerly required user interaction or user input to allow the user to easily interact with the device without needing to navigate through complex menu hierarchies or push a series of buttons.

For instance, certain devices now incorporate components such as accelerometers and gyroscopes (or gyro sensors) that, among other things, allow the device to orient the screen display automatically in accordance with how the user is holding the phone. Accelerometers are sensors that can measure the magnitude and direction of the acceleration of the device, and can be used to sense the orientation of the device. Meanwhile, a gyroscope can be used to either measure, or maintain, the orientation of a device. Unlike an accelerometer, which measures the linear acceleration of the device, a gyroscope measures the orientation directly. When a device's accelerometer measurements are combined with the gyroscope measurements, motion can be sensed on six-axes: up and down, left and right, forward and backwards, as well as the roll, pitch and yaw rotations.

The problem with these conventional methods of enhancing user experience is that they change the settings of the mobile device without taking into account the presence or the orientation of the user who may be actively using the device.

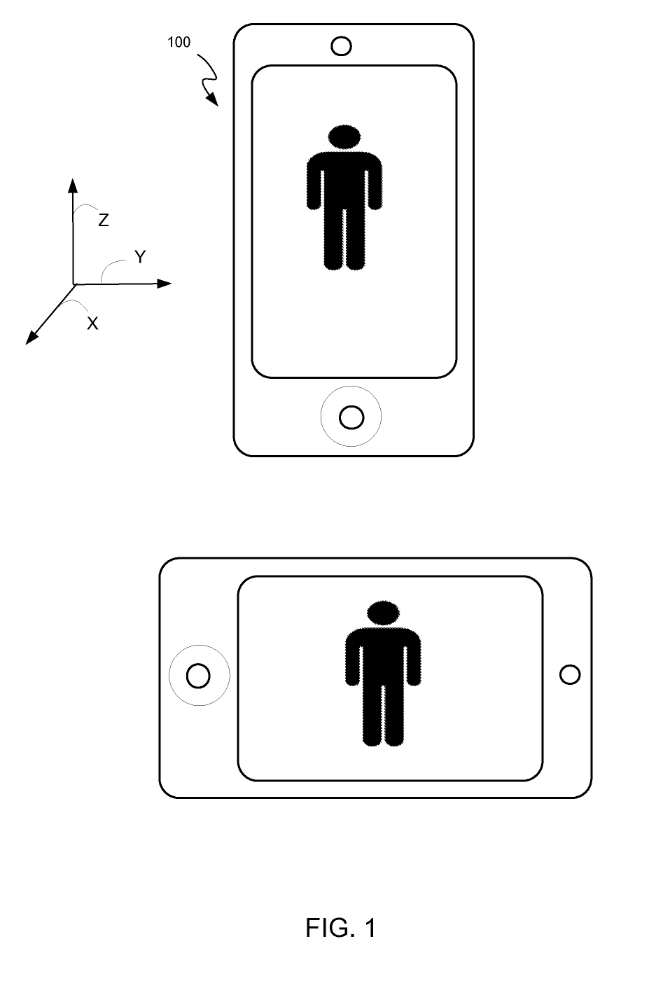

For instance, the problem with setting the screen orientation based on the measurements of the gyro sensor or accelerometer (collectively referred to hereafter as “orientation sensor”) is that they effectively set the screen orientation always assuming users in an up-right vertical position. FIG. 1 is a perspective view showing the screen display of a cell phone change in accordance with accelerometer and/or gyroscope methods of adjusting screen orientation. As shown in FIG. 1, when the cell phone 100 is oriented in a vertical plane, i.e., in the Y-Z or the X-Z plane, the orientation sensor will accurately determine the correct orientation for displaying the image. Depending on how the user is holding the device, the display on the cell phone will switch between portrait and landscape mode as shown in FIG. 1.

However, the orientation sensor fails when the device is held in a horizontal plane resulting in an orientation that is undefined or carried over from the last valid measurement. For example, if a user is attempting to review a document on his mobile device while holding the device in the horizontal plane, i.e., parallel to the ground, the orientation sensor is unable to determine the proper orientation.

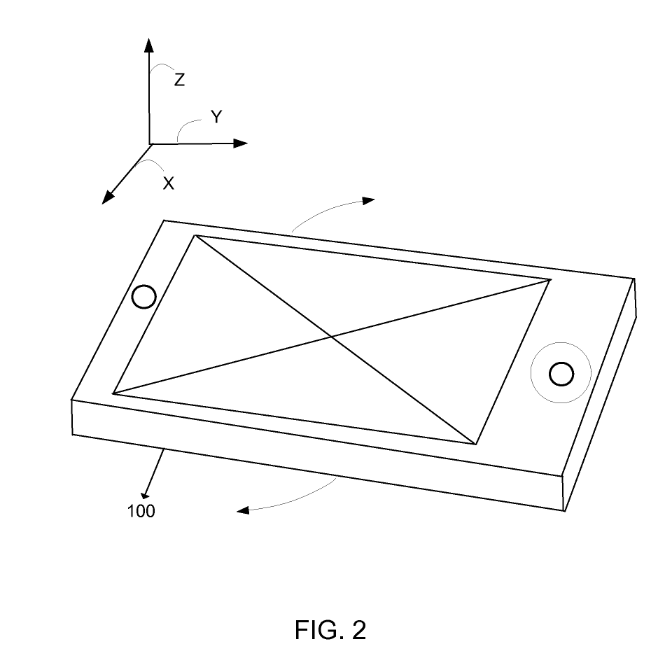

FIG. 2 is a perspective view showing a cell phone positioned in a horizontal plane. When the cell phone 100 is oriented in the X-Y plane, the orientation sensor's orientating detection mechanism fails. As a result, the screen orientation will either be indeterminate or the phone will use the last valid measurement from the orientation sensor to set the orientation of the display, which may be incorrect or worse, the display will flip flop back and forth. The user would then manually need to browse through the menu options to enter the proper orientation setting.

Also, conventional mobile devices have a power saving timer that turns off the display of the device or adjusts the brightness in order to reduce the power consumption when there is no interaction with the mobile device. This change in conventional devices takes place without considering the potential presence of a user who is not actively involved in physical interaction with the device. As a consequence, a user may need to touch the screen intermittently in order to prevent the screen from entering into the power preservation or brightness reduction mode.

Embodiments of the present invention provide methods and system for enhancing users' interactions with a mobile device by sensing the presence and detecting the location and orientation of the head, face, or the eyes of a user in order to configure certain settings on the device, including the screen power saving timer and the screen orientation of the device. A mobile device may be a tablet, a smart-phone, an ultra-book, a laptop or any device with a screen and a camera lens oriented towards the user of the device.

FIG. 3 shows an exemplary operating environment or “device” in accordance with one embodiment of the present invention. System 300 includes camera 302, image signal processor (ISP) 304, memory 306, input module 308, central processing unit (CPU) 310, display 312, communications bus 314, gyro chip 334, and power source 320. Power source 320 provides power to system 300 and may be a DC or AC power source. System 300 depicts the components of an exemplary system in accordance with embodiments of the present invention providing the execution platform for certain hardware-based and software-based functionality. Although specific components are disclosed in system 300, it should be appreciated that such components are examples. That is, embodiments of the present invention are well suited to having various other components or variations of the components recited in system 300. It is appreciated that the components in system 300 may operate with other components other than those presented, and that not all of the components of system 300 may be required to achieve the goals of system 300.

CPU 310 and the ISP 304 can also be integrated into a single integrated circuit die and CPU 310 and ISP 304 may share various resources, such as instruction logic, buffers, functional units and so on, or separate resources may be provided for image processing and general-purpose operations. System 300 can be implemented as, for example, a digital camera, cell phone camera, portable device (e.g., audio device, entertainment device, handheld device), webcam, video device (e.g., camcorder) or any other device with a front or back facing camera that allows the device to detect the presence of a user.

In one embodiment, cameras 302 captures light via a front-facing or back-facing lens (depending on how the user typically holds the device), and converts the light received into a signal (e.g., digital or analog). In another embodiment, system 300 may also have another camera facing away from the user (not shown). Camera 302 may comprise any of a variety of optical sensors including, but not limited to, complementary metal-oxide-semiconductor (CMOS) or charge-coupled device (CCD) sensors. Camera 302 is coupled to communications bus 314 and may provide image data received over communications bus 314. Camera 302 may comprise functionality to determine and configure optical properties and settings including, but not limited to, focus, exposure, color or white balance, and areas of interest (e.g., via a focus motor, aperture control, etc.).

Image signal processor (ISP) 304 is coupled to communications bus 314 and processes the signal generated by camera 304, as described herein. More specifically, image signal processor 304 may process data from camera 302 for storing in memory 306. For example, image signal processor 304 may compress and determine a file format for an image to be stored in within memory 306.

Input module 308 allows entry of commands into system 300 which may then, among other things, control the sampling of data by camera 302 and subsequent processing by ISP 304. Input module 308 may include, but it not limited to, navigation pads, keyboards (e.g., QWERTY), up/down buttons, touch screen controls (e.g., via display 312) and the like.

Central processing unit (CPU) 310 receives commands via input module 308 and may control a variety of operations including, but not limited to, sampling and configuration of camera 302, processing by ISP 304, and management (e.g., addition, transfer, and removal) of images and/or video from memory 306.

Gyro chip 334 is a means (rotation detection means) for detecting the displacement of the device housing from a predetermined posture position by rotation. The gyro chip 334 can comprise a ceramic gyro, an accelerometer or acceleration sensor, or the like. The gyro chip 334 detects an acceleration applied to the housing, and supplies the result to central processing unit 310. For example, when the housing of the device is rotated clockwise through about 90°, as shown by way of example in FIG. 1, an output from the gyro chip 334 also changes along with the rotation. The magnitude of a change in an output from the gyro chip 334 corresponds to the rotation amount of the housing. The predetermined posture position of the housing, i.e., a normal posture position of the housing when the user holds the device in his hand and sees a portrait or landscape is defined as a reference. The sign of an output from the gyro chip 334 is changed between a case wherein the housing rotates clockwise and a case wherein the housing rotates counterclockwise from this reference position. Hence, a rotation position from the predetermined posture position of the device can be detected from an output of the gyro chip 334.

Conventional devices only rely on the gyro chip 334 to set the display orientation of the device. As explained above, this is problematic because the gyro chips fails to provide accurate orientation data when the device is held horizontally in the X-Y plane as shown in FIG. 2. Further, conventional devices go into power saving mode without detecting for the presence of a user that may be not be actively involved in physical interaction with the device. This requires the user to intermittently engage with the device in order to prevent it from going into power preservation or brightness reduction mode.

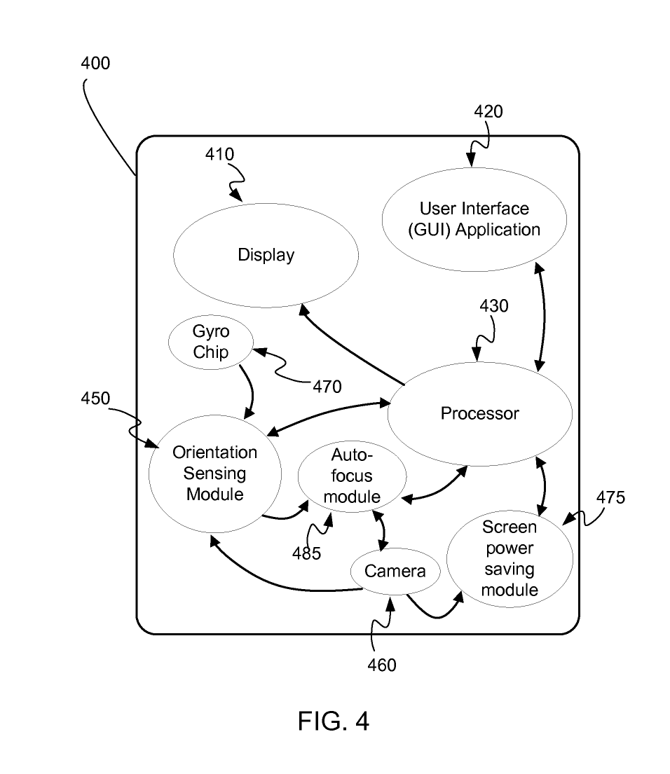

FIG. 4 is a high level block diagram representation showing the interconnections between the internal hardware or software components within a portable mobile device in accordance with one embodiment of the present invention. The components shown include an orientation sensing module 450 coupled to a gyro chip 470 and a camera 460. The camera 460, in one embodiment of the present invention, is oriented towards the user of the device. For example, in a smart-phone the camera would be front facing. Similarly, for a digital camera having a display on the back of the device, the additional camera to detect the presence of the user would be located on the back of the device along with the display.

The orientation sensing module 450 is coupled to a processor 430 that controls the various input and output to and from the other various components. Also, a graphical user interface application (GUI) 420, and a display 410 are also shown. The orienting sensing module 450 is configured to sense the current orientation of the portable mobile communications device 400 as a whole using either the output read from the gyro chip 470 or the camera 460. The orientation data is then fed to the processor 430. The orientation sensing module 450, via the processor 430, controls the graphical user interface (GUI) application 420 and, in turn, the display 410 to present the GUI for the desired orientation.

Also, the orientation sensing module sends data regarding the location of a user's face, head and eyes to the auto-focus module 485 which can be configured to assist in the auto-focusing of the camera. The auto-focus module 485 is also coupled to camera 460 and receives the image data from the camera. The auto-focusing module 485, via the processor 430, controls the graphical user interface (GUI) application 420 and, in turn, the display 410 to display the focused image on the user's screen.

Further, a screen power saving module 475 is configured to sense the presence of a user using the output read from the camera 460. The screen power saving application determines whether to use the default screen power saving timer value or whether to override the default timer value by keeping the screen active because a user is present. The screen power saving application 475 uses the output from camera 460 to determine user presence. The screen power saving module 475, via the processor 430, controls the graphical user interface (GUI) application 420 and, in turn, the display 410 to present the GUI for the applicable mode, e.g., power preservation mode, brightness reduction mode, or active mode.

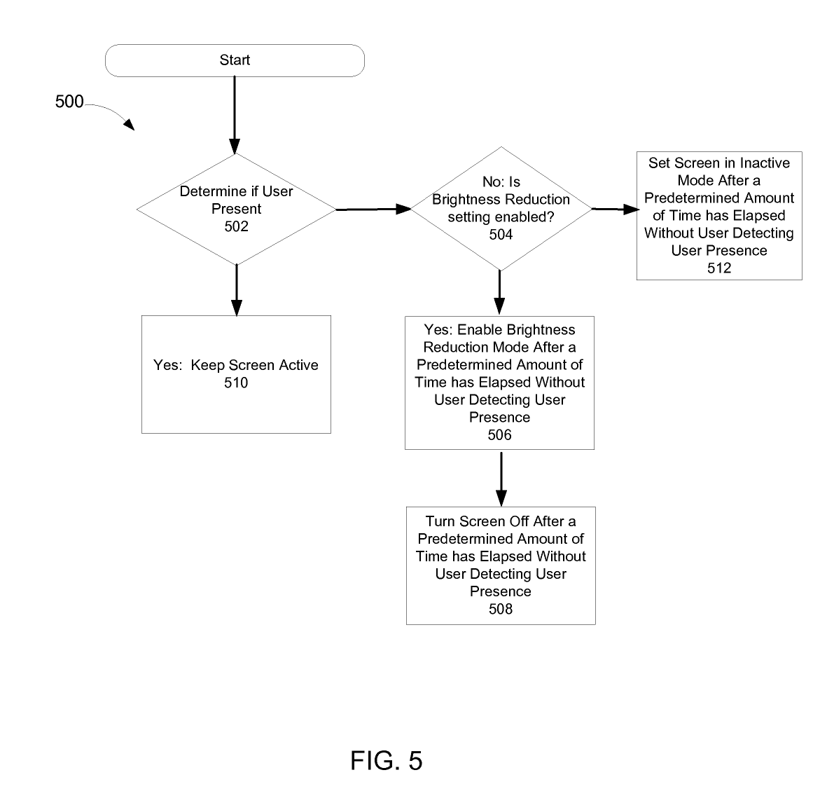

FIG. 5 depicts a flowchart 500 of an exemplary process of setting the screen power saving feature of a portable mobile device in accordance with on embodiment of the present invention. The invention, however, is not limited to the description provided by flowchart 500. Rather, it will be apparent to persons skilled in the relevant art(s) from the teachings provided herein that other functional flows are within the scope and spirit of the present invention. Flowchart 500 will be described with continued reference to exemplary embodiments described above, though the method is not limited to those embodiments.

At step 502, the device uses the built-in camera to determine if a user is present. The camera 460 used to determine screen orientation or power savings mode is oriented in the direction facing the user. For example, a smart phone may have two cameras, but the camera used to detect user presence and orientation will be the one that faces the direction of the user when the user is actively involved in physical interaction with the device. In a smart phone this will be the front facing camera. On the other hand, in a digital camera, for example, it could be a second camera mounted on the back of the device that is used to detect user presence and orientation so that the display on the camera LCD can be adjusted accordingly.

The images captured from the camera only need to be analyzed to determine if a user is present at step 502. This analysis can be undertaken dynamically in real-time by analyzing the images from the camera directly or by capturing images and storing them before analyzing them. This is a coarse analysis to simply detect whether a user is present and, thus, the procedure needs to be quick and efficient. In one embodiment of the invention, skin detection can be used to detect a user's presence. The captured color images are analyzed by screen power saving module 475 to detect pixels that fall within a certain predetermined tonal range acceptable for skin color. The size of the connected pixel clusters that are within the range is then analyzed to determine if the clusters relate to user presence. One example of a procedure to detect skin in an image is disclosed in U.S. Pat. No. 8,031,936, “IMAGE PROCESSING SYSTEM FOR SKIN DETECTION AND LOCALIZATION.” The benefit of this embodiment is that it requires low computation and can be rapidly performed if a user is present in the field of the view of the camera lens.

In another embodiment of the present invention, the user's presence in front of the lens is detected by the screen power saving module 475 using a technique known as ambient background subtraction. The device uses two images that are captured under different illumination conditions. The difference between the two images is then calculated. This difference is significant for the close objects, but diminishes for objects at a distance. Accordingly, a high delta in light intensity between the foreground parts of the image, and a low delta in the background parts of the image would indicate that a user is present in the foreground. One example of a procedure for removing ambient illumination from an image to identify the subject in an image is disclosed in U.S. Pat. No. 6,021,210, “IMAGE SUBSTRACTION TO REMOVE AMBIENT ILLUMINATION.”

Ambient background subtraction can also be used by the device to detect user presence by detecting the user's eyes. Eyes contain specular highlights which make them particularly amenable to detection using ambient background subtraction. When two images are captured under different illumination conditions, because of the specular properties of the eye, a particularly large contrast in intensity in a small part of the image may indicate user presence.

Further, specular highlights are traditionally thought to be the brightest part of an image. In one embodiment, the device may search for the user eyes by attempting to detect the brightest part of the image. Under certain conditions, illumination of the target can be strategically used to expose the presence of human eyes. If the target is illuminated at a certain angle, for example, the moisture on the cornea of the eye or the glare reflected from spectacles can tend to produce saturated pixels. The power savings module 475 can be configured to detect the user's eyes using any one of these procedures.

In one embodiment, at step 502, the user's presence can also be determined using the orientation sensing module 450 by detecting the orientation of the user's head, face or pair of eyes, but this would be computationally expensive and unnecessary at this stage. However, as mentioned above, at step 502, only a coarse and efficient computation needs to be done to determine if the user is present to determine whether the device's screen should remain active. Accordingly, a different less computationally intensive technique such as skin detection or ambient background subtraction would be preferable.

In one embodiment, the device may use images of reduced resolution to detect user presence so as to reduce computation and data size while maintaining a reasonable level of accuracy. The images to detect user presence can be of lower resolution than ones required to do the subsequent orientation determination.

In one embodiment, the procedure for detecting the user's presence from step 502 to determine the screen power saving mode is executed at a preset time interval so as not to incur the unnecessary overhead or power consumption that would result from having the procedure update continuously. In another embodiment, the procedure is executed right before the device is about to enter into either brightness reduction mode or inactive mode to check if a user is present before the screen on the device dims.

If a user is not detected, the device's default screen power saving procedure is invoked. At step 504, screen power saving module 475 determines if brightness reduction setting is enabled. If the brightness reduction setting is enabled, then at step 506, the device enters brightness reduction mode after a predetermined amount of time has elapsed without detecting user presence. The amount of time that elapses before the device enters brightness reduction mode depends on user settings. Finally, if the device stays in brightness reduction mode for a predetermined period of time without detecting user presence, the screen enters inactive mode at step 508 and turns off. Alternatively, if the brightness reduction setting is not enabled at step 504, then the screen enters inactive mode after a predetermined period of time at step 512 without first entering brightness reduction mode. Again, the period of time required to elapse before the device becomes inactive depends on user settings.

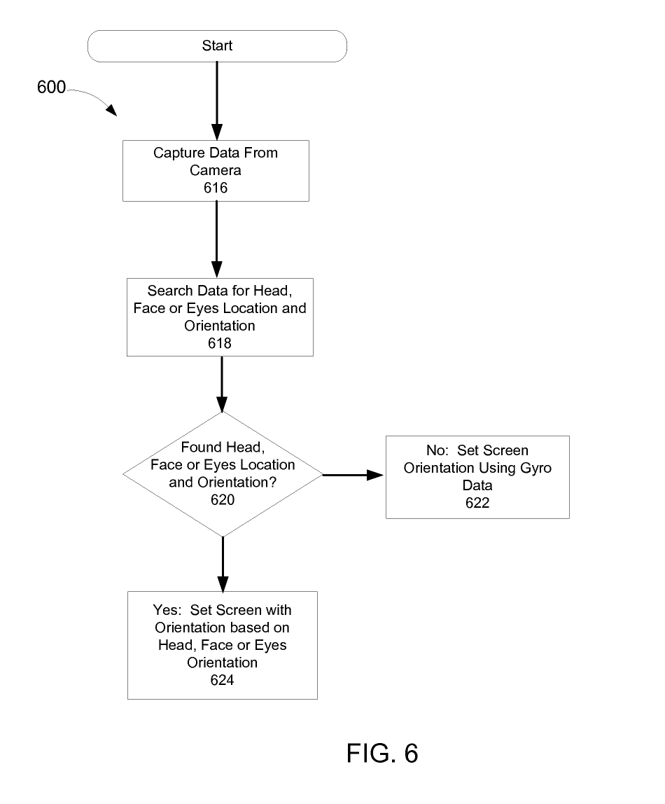

FIG. 6 depicts a flowchart of an exemplary process setting the screen orientation of a portable mobile device in accordance with on embodiment of the present invention. The invention, however, is not limited to the description provided by flowchart 600. Rather, it will be apparent to persons skilled in the relevant art(s) from the teachings provided herein that other functional flows are within the scope and spirit of the present invention. Flowchart 600 will be described with continued reference to exemplary embodiments described above, though the method is not limited to those embodiments.

At step 616, data is captured from the camera. The data can be captured and stored in the form of still images or video or the data can be analyzed in real-time.

At step 618, the user's head, face or eye location and orientation is determined using the orientation sensing module 450. In one embodiment of the invention, step 616 and step 618 can be carried out contemporaneously, i.e., both processes will occur in real-time.

In one embodiment, the orientation sensing module 450 will attempt to detect the orientation of the face or head. In a different embodiment, module 450 may try to detect the orientation of a pair of eyes. In one embodiment, the image can also be analyzed to determine the orientation of a user's other facial parts such as his nose, lips, ears, etc.

The advantage of using eye detection is that it the eyes occupy a smaller portion of the field of view so module 450 only needs to analyze a small part of the image. Examples of procedures to detect a user's face and eyes in an image are disclosed in U.S. Pat. No. 6,661,907 “FACE DETECTION IN DIGITAL IMAGES” and No. 7,130,453 “EYE POSITION DETECTION METHOD AND DEVICE.”

In one embodiment, ambient background subtraction techniques, such as the one explained above, can also be used by the orientation sensing module 450 to determine the orientation of the eyes.

In another embodiment, the device may use images of reduced resolution to detect head, face or eyes location and orientation information so as to reduce computation and data size while maintaining a reasonable level of accuracy.

At step 620, a determination is made if the head, face or eyes location was found.

If the location and orientation of the user's head, face or eyes is not found, then at step 622, the screen orientation is set using data from the gyro chip 470. If the device is being held in a horizontal plane and no valid user presence or orientation data can be detected, then the last valid measurement from either the gyro chip 470 or the orientation sensing module 450 can be used to establish the screen orientation.

If the location and orientation of the user's head, face or eyes is found, then at step 624, the screen orientation is set using data from the orientation sensing module. The screen orientation can be set to one of four possible orientations depending on how the user is holding the device, where two of the orientations are in portrait mode and the remaining two are in landscape mode. If the camera detects multiple people, then the individual occupying the largest number of pixels in the image or in the center of the field of view of the camera is nominated as the user of the device and all orientation calculations are performed with respect to this individual.

In another embodiment, the screen orientation can be set to multiple possible orientations depending on how the user is holding the device. For instance, if the user is holding the device diagonally, the display device 410 may display the image diagonally and in a way such that the image is upright with respect to the user.

In one embodiment, the procedure for detecting the orientation of the user's head, face or eyes from step 618 is executed at a preset time interval so as not to incur the unnecessary overhead or power consumption that would result from having the procedure update continuously. In another embodiment, the gyro chip 470 controls when the orientation sensing module 450 performs an updated user presence and orientation computation. For example, whenever the gyro chip 470 senses a change in device orientation or does an automatic periodic check, it will trigger the orientation sensing module 450 to check for a user's presence and eye, face or head orientation. If a valid result is obtained from the orientation sensing module 450, then the screen will be oriented according to that result as opposed to the output from the gyro chip. In this way, the orientation sensing module 450 is designed to override the output from the gyro chip 470 if it obtains a valid result from its orientation calculations using data from the camera 460.

In one embodiment illumination invisible to the human eyes such as infrared lighting may be used to conduct the user detection at step 502 and the orientation detection at step 620 in a way non-intrusive to the user. Examples of procedures to detect a user's face using infrared lighting is disclosed in U.S. Pat. No. 7,469,060 titled “INFRARED FACE DETECTION AND RECOGNITION SYSTEM” and U.S. Pat. No. 7,027,619 titled “NEAR-INFRARED METHOD AND SYSTEM FOR USE IN FACE DETECTION.”

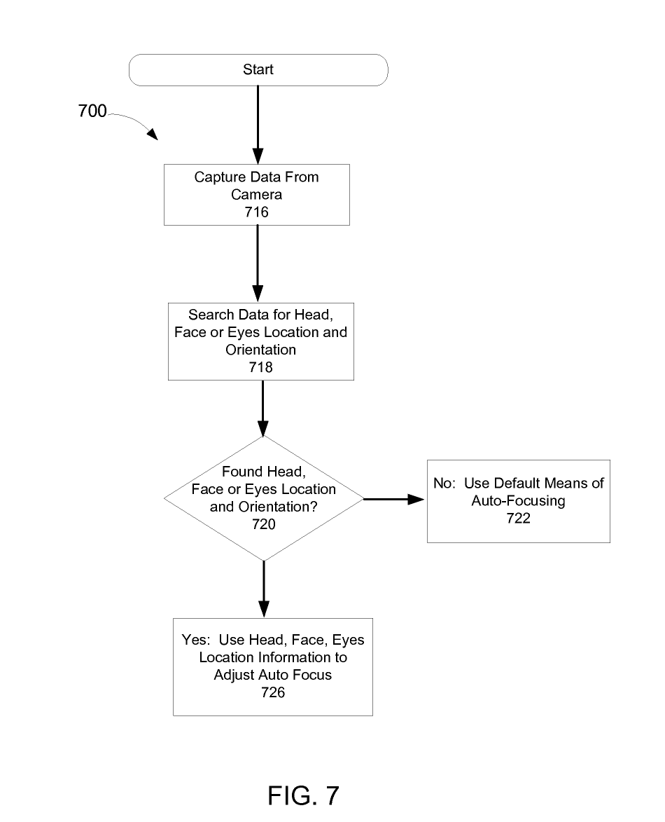

FIG. 7 depicts a flowchart of an exemplary process setting the auto-focus of a portable mobile device in accordance with on embodiment of the present invention. The invention, however, is not limited to the description provided by flowchart 700. Rather, it will be apparent to persons skilled in the relevant arts) from the teachings provided herein that other functional flows are within the scope and spirit of the present invention. Flowchart 700 will be described with continued reference to exemplary embodiments described above, though the method is not limited to those embodiments.

At step 716, similar to step 616, data is captured from the camera.

At step 718, similar to step 618, after establishing that a user is present, the user's head, face or eye location and orientation is determined using the orientation sensing module 450. The orientation sensing module 450 uses the same techniques described above to search data for the head, face or eyes location and orientation.

At step 720, a determination is made if the head, face or eyes location was found.

If the location and orientation of the user's head, face or eyes is not found, then at step 722, the default means of auto-focusing the camera are used.

In one embodiment, if a user's head, face or eyes location and orientation is determined at 720, then the information regarding the location of the eyes and the head can also be used to facilitate auto-focus for the user-facing camera at step 726.

Traditionally, handheld devices such as cell phones and tablets have built-in cameras that use passive auto-focusing techniques. Passive auto-focus is achieved by measuring contrast within a sensor field through the lens. The intensity difference between adjacent pixels of the sensor naturally increases with correct image focus. The optical system can thereby be adjusted until the maximum contrast is detected.

A passive autofocus functions as soon as the user clicks the shutter by comparing the contrast between pixels in a selected area. The autofocus then calculates the correct lens position while the processor continues recording and adjusting the lens position. The processor will continue to re-adjust the lens until the contrast has been maximized and the optimal focus position has been found. Once the autofocus determines the best focus position, the camera will take the picture.

This is in contrast to active autofocus systems that comprise distance sensors to measure the distance from the camera to the objects in the scene. By knowing the distance, along with the lens and aperture settings, the exact focus can be calculated and set.

Passive autofocus systems are problematic however, because they tend to be slow and accompanied with an unpleasant visual experience. This is because contrast based autofocus system need to start the focusing process with a guess and then continue to focus in the direction that has a better chance of converging to the best focus position. Periodically, the processor will check the difference in contrast to ensure whether if the initially guessed direction for focusing is accurate. If the contrast decreases, the processor will then need to continue guessing in the opposite direction. This change of focus search direction results in poor user experience and long focus search times. Users will typically see the focus degrade before it gets better. Furthermore, even if the initial direction is correct, there is no easy way for the processor to estimate how far the focus search needs to proceed. Often the users will see the focus search proceed past the optimal focus position before it settles.

Passive auto-focus systems, however, can be improved in certain ways. For example, the depth or distance information can be inferred in these systems from the size of known objects e.g. the width of the human face or the separation between human eyes.

Human eye separation typically has a near constant value of around 65 mm. Since the separation between human eyes only has a miniscule variation, the perceived distance between the eyes in an image can provide a close to accurate indication of the distance away from the target. Thus, at step 720, once the user's eyes have been located, the distance between the eyes can be used to compute the distance away from the target, which in turn allows the auto-focusing module 585 to calculate the focus. In some cases because of the minor variation in distance between different pairs of eyes, a small adjustment may need to be made by module 585 to determine the precise focus position. The auto-focusing module 585 can store a table internally comprising calibration information that allows the distance between the eyes as seen by the camera lens to be translated to target focus distance. This calibration information can be predetermined offline.

In addition, the width of a user's face is bounded within a range depending on ages, races and physical appearance. Face width, similar to eye separation, can also be used to determine the distance from the target. Since face width has a higher variation than the near-constant distance between human eyes, using face width is not as accurate as using the eye separation. However, face width can be used to guide the auto-focus procedure in the proper focusing direction. For example, if the user moves away from an already focused position, the change in the face width can be used to select the direction for the next search. If the face width, for instance, gets smaller, we can infer that the user is moving farther away, and the auto-focusing module 485 will attempt to set the focus at a farther distance from the camera.

In one embodiment, when there are multiple faces in a scene, the auto-focusing module 485 may be programmed to focus on the face with the median size, i.e., the face in the middle of the distance range, or it could be programmed to focus on the face selected by the user.

FIG. 8 depicts a flowchart of an exemplary process setting the screen power saving feature, the screen orientation and auto-focus of a portable mobile device in accordance with on embodiment of the present invention. The invention, however, is not limited to the description provided by flowchart 800. Rather, it will be apparent to persons skilled in the relevant art(s) from the teachings provided herein that other functional flows are within the scope and spirit of the present invention. Flowchart 800 will be described with continued reference to exemplary embodiments described above, though the method is not limited to those embodiments.

Flowchart 800 illustrates how the power saving feature, the screen orientation feature and the auto-focus feature operate together in a device.

At step 802, as discussed above in relation to step 502, the device uses the built-in camera to determine if a user is present.

If a user is not found, then at step 804, screen power saving module 475 determines if brightness reduction setting is enabled. If the brightness reduction setting is enabled, then at step 806, the device enters brightness reduction mode after a predetermined amount of time has elapsed without detecting user presence. Finally, if the device stays in brightness reduction mode for a predetermined period of time without detecting user presence, the screen enters inactive mode at step 808 and turns off. Alternatively, if the brightness reduction setting is not enabled at step 804, then the screen enters inactive mode after a predetermined period of time at step 812 without first entering brightness reduction mode.

At step 802, the images captured from the camera only need to be analyzed to determine if a user is present. As stated above, this is a quick and coarse analysis to simply detect whether a user is present and, thus, the procedure can be carried out with images of lower resolution than ones required for determining the user's orientation.

If a user is detected at step 802, then the default screen power saving settings will be overridden and, at step 814, the screen will be set for active use.

At step 816, similar to step 616, data is captured from the camera.

At step 818, similar to step 618, after establishing that a user is present, the user's head, face or eye location and orientation is determined using the orientation sensing module 450. The orientation sensing module 450 uses the same techniques described above to search data for the head, face or eyes location and orientation.

At step 820, a determination is made if the head, face or eyes location was found.

If the location and orientation of the user's head, face or eyes is not found, then at step 822, the screen orientation is set using data from the gyro chip 470 and default procedures for auto-focusing are used. If the device is being held in a horizontal plane and no valid user presence or orientation data can be detected, then the last valid measurement from either the gyro chip 470 or the orientation sensing module 450 can be used to establish the screen orientation.

If the location and orientation of the user's head, face or eyes is found, then at step 824, similar to step 624, the screen orientation is set using data from the orientation sensing module. Further, at step 826, similar to step 726, the orientation information is also used to adjust the auto-focus for the user facing camera display.

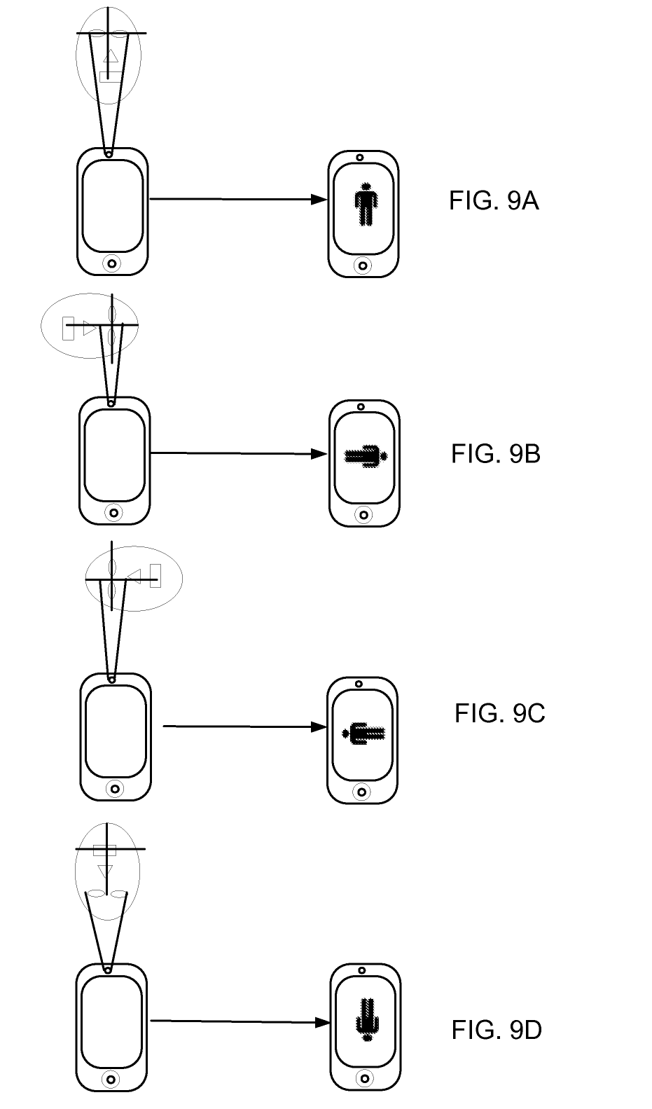

FIGS. 9A-9D illustrates how the on screen orientation of an image on the display of a portable mobile device changes in relation to the facial orientation of the user in accordance with one embodiment of the present invention. As seen in FIGS. 9A-9D, the display of the device changes so that the on screen image is always upright in relation to the user's face, eyes or head.

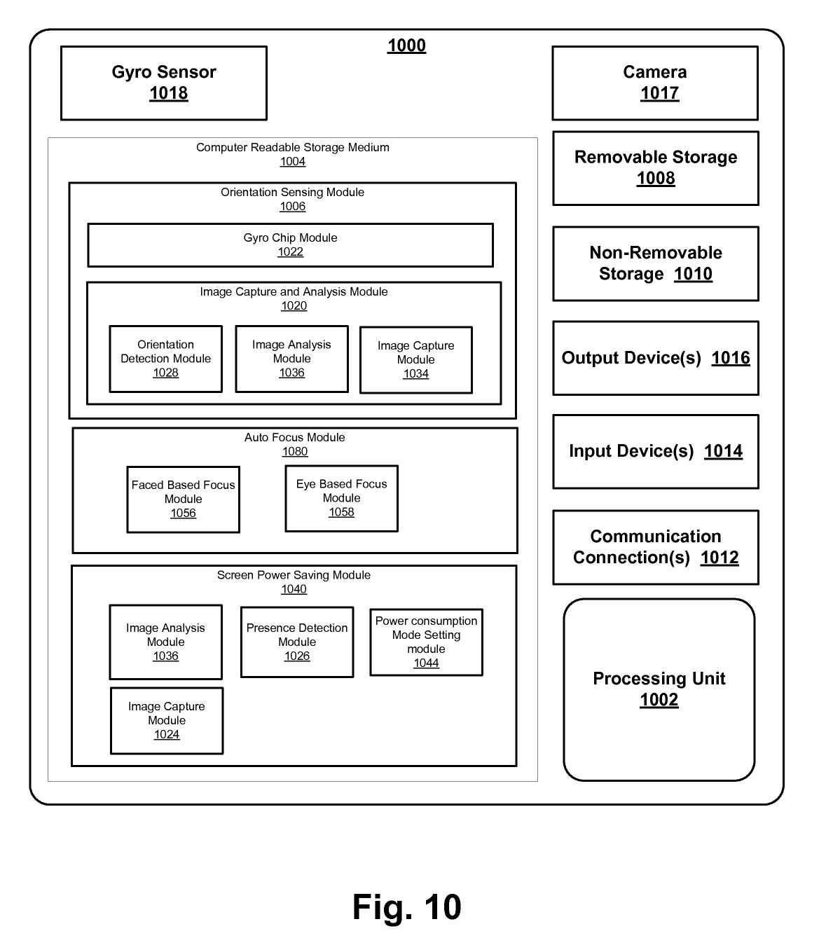

FIG. 10 shows a block diagram of an exemplary computing system environment 1000, in accordance with one embodiment of the present invention. With reference to FIG. 10, an exemplary system module for implementing embodiments includes a general purpose computing system environment, such as computing system environment 1000. Computing system environment 1000 may include, but is not limited to, laptops, tablet PCs, notebooks, mobile devices, and smartphones. In its most basic configuration, computing system environment 1000 typically includes at least one processing unit 1002 and computer readable storage medium 1004. Depending on the exact configuration and type of computing system environment, computer readable storage medium 1004 may be volatile (such as RAM), non-volatile (such as ROM, flash memory, etc.) or some combination of the two. Portions of computer readable storage medium 1004 when executed facilitate image or video capture.

Additionally, computing system environment 1000 may also have additional features/functionality. For example, computing system environment 1000 may also include additional storage (removable and/or non-removable) including, but not limited to, magnetic or optical disks or tape. Such additional storage is illustrated in FIG. 10 by removable storage 1008 and non-removable storage 1010. Computer storage media includes volatile and nonvolatile, removable and non-removable media implemented in any method or technology for storage of information such as computer readable instructions, data structures, program modules or other data. Computer readable medium 1004, removable storage 1008 and nonremovable storage 1010 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1000. Any such computer storage media may be part of computing system environment 1000.

Computing system environment 1000 may also contain communications connection(s) 1012 that allow it to communicate with other devices. Communications connection(s) 1012 is an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

Communications connection(s) 1012 may allow computing system environment 1000 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1012 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 1000 may also have input device(s) 1014 such as a keyboard, mouse, pen, voice input device, touch input device, remote control, etc. Output device(s) 1016 such as a display, speakers, etc. may also be included. All these devices are well known in the art and are not discussed at length.

Computing system environment 1000 can also have an orientation sensor 1018 and a camera 1017.

In one embodiment, computer readable storage medium 1004 includes orientation sensing module 1006. Orientation sensing module includes gyro chip module 1022 which is operable to use orientation data from the orientation sensor 1018 in order to determine the screen orientation. Orientation sensing module 1006 also includes image capture and analysis module 1020. Image capture and analysis module is operable to use image capture module 1034 to capture images from the camera 1017 and image analysis module 1036 to analyze the images. Orientation detection module 1028 is operable to use the results from image analysis module 1036 to determine the location and orientation of the user. In one embodiment, orientation detection module may use ambient background subtraction techniques to determine orientation. In a different embodiment, it may use any one of several other well-known techniques to determine user orientation.

Auto-focus module 1080 comprises face-based focus module 1056 and eye-based focus module 1058. Eye-based focus module 1058 is operable to use the perceived distance between the eyes of the user in the image to determine the distance of the user from the target and focus the image accordingly. Face-based focus module 1056 is operable to use the change in width of the user's face in the image if the user's position changes relative to the camera to determine the proper direction for computing focus.

Screen power saving module 1040 comprises image analysis module 1036, image capture module 1024, presence detection module 1026, and power consumption mode setting module 1044. In one embodiment, the image analysis module 1036 and image capture module 1024 is shared with the image capture and analysis module 1020. In another embodiment, the screen power saving module 1040 may have its own instantiation of the image capture module and the image analysis module.

Presence detection module 1026 may comprise skin detection, ambient background subtraction or orientation detection procedures for determining user presence. It is operable to perform its computations on the results from image analysis module 1036. The results of those computations determine the mode for the power consumption mode setting module 1044. Power consumption mode setting module 1044 can either keep the screen on the device active, turn it off or dim it in brightness reduction mode.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

1. A method for determining screen orientation on a portable electronic device, said method comprising:
detecting the presence of a user using data from a camera of the portable electronic device;
searching the data from the camera for a plurality of physical characteristics of the user if a user is detected;
determining a facial orientation of the user based on information regarding at least one physical characteristic of the user determined in the data; and
setting a screen orientation of a display device of said portable electronic device based on a determined facial orientation of the user.

2. The method of claim 1, further comprising capturing the data to perform said searching, wherein the data is selected from the group comprising: image data and video data.

3. The method of claim 1, wherein the plurality of physical characteristics is selected from the group comprising: head, face, eyes, nose, and lips.

4. The method of claim 1, wherein the information regarding the at least one physical characteristic comprises an orientation of the at least one physical characteristic of the user determined from the data.

5. The method of claim 1, wherein the information regarding the at least one physical characteristic comprises a location of the at least one physical characteristic of the user determined from the data.

6. The method of claim 1, further comprising enabling a screen timer for setting a screen in inactive mode if said detecting does not detect the presence of a user.

7. The method of claim 1, further comprising enabling a screen timer for setting a screen in brightness reduction mode if said detecting does not detect the presence of a user.

8. The method of claim 1, further comprising maintaining a screen in active mode if said detecting detects the presence of a user.

9. The method of claim 1, further comprising setting a screen orientation based on data received from an orientation sensor if said determining fails to determine the facial orientation.

10. The method of claim 1, further comprising adjusting a focus of the camera automatically based on the information regarding the at least one physical characteristic of the user determined from the data.

11. The method of claim 10, wherein the information regarding the at least one physical characteristic comprises a distance between the eyes of the user determined from the data.

12. The method of claim 10, wherein the information regarding the at least one physical characteristic comprises a width of the head of the user determined from the data.

13. The method of claim 1, wherein the detecting the presence of the user comprises using skin detection techniques.

14. The method of claim 1, wherein the detecting the presence of the user comprises using ambient background subtraction techniques.

15. A computer-readable storage medium having stored thereon, computer executable instructions that, if executed by a computer system cause the computer system to perform a method for determining screen orientation on a portable electronic device, said method comprising:
detecting the presence of a user using data from a camera of the portable electronic device;
searching the data from the camera for a plurality of physical characteristics of the user if a user is detected;
determining a facial orientation of the user based on information regarding at least one physical characteristic of the user determined in the data; and
setting a screen orientation of a display device of said portable electronic device based on a determined facial orientation of the user.

16. The computer-readable medium as described in claim 15 wherein the plurality of physical characteristics is selected from the group comprising: head, face, eyes, nose, and lips.

17. The computer-readable medium as described in claim 15 wherein the information regarding the at least one physical characteristic comprises an orientation of the at least one physical characteristic of the user determined from the data.

18. The computer-readable medium as described in claim 15 wherein the information regarding the at least one physical characteristic comprises a location of the at least one physical characteristic of the user determined from the data.

19. The computer-readable medium as described in claim 15 wherein said method further comprises enabling a screen timer for setting a screen in inactive mode if said detecting does not detect the presence of a user.

20. The computer-readable medium as described in claim 15 wherein said method further comprises enabling a screen timer for setting a screen in brightness reduction mode if said detecting does not detect the presence of a user.

21. The computer-readable medium as described in claim 15 wherein said method further comprises maintaining a screen in active mode if said detecting detects the presence of a user.

22. The computer-readable medium as described in claim 15 wherein said method further comprises setting the screen orientation based on data received from an orientation sensor if said determining fails to determine the facial orientation.

23. The computer-readable medium as described in claim 15 wherein said method further comprises adjusting a focus of the camera automatically based on the information regarding the at least one physical characteristic of the user determined from the data.

23. The computer-readable medium as described in claim 15 wherein said method further comprises capturing the data to perform said searching, wherein the data is selected from the group comprising: image data and video data.

25. A system for determining screen orientation on a portable electronic device, said system comprising:
a display screen configured to display an image in a plurality of orientations;
a memory;
a camera; and
a processor configured to:
detect the presence of a user using data from the camera of the portable electronic device;
search the data from the camera for a plurality of physical characteristics of the user if a user is detected;
determine a facial orientation of the user based on information regarding at least one physical characteristic of the user determined in the data; and
set a screen orientation on the display screen based on a determined orientation of the user.
